(19) United States
(12) Patent Application Publication
(10) Pub. No.: US 2023/0246717 A1
(43) Pub. Date: Aug. 3, 2023

(54) OPTICAL COMMUNICATION SYSTEM

(71) Applicant: NIPPON TELEGRAPH AND TELEPHONE CORPORATION, Tokyo (JP)

(72) Inventors: Hirofumi YAMAMOTO, Musashino-shi, Tokyo (JP); Hirotaka NAKAMURA, Musashino-shi, Tokyo (JP)

(73) Assignee: NIPPON TELEGRAPH AND TELEPHONE CORPORATION, Tokyo (JP)

(21) Appl. No.: 18/011,280

(22) PCT Filed: Jun. 24, 2020
(86) PCT No.: PCT/JP2020/024821

§ 371 Date: Dec. 19, 2022

(51) Int. Cl. H04B 10/80

(52) U.S. Cl. CPC H04B 10/806

(57) ABSTRACT

An optical communication system 1 includes an OLT 100 and an ONU 200. The ONU 200 includes a local power supply reception unit 202 capable of receiving power from an external power supply 300, a station-side power supply reception unit 204 connected to a station-side power supply 110 controlled by the OLT 100, via a power supply cable 120, and a power feeding switching unit 205 capable of selectively switching a state of the ONU 200 between a first state in which power feeding is performed by the local power supply reception unit 202 and a second state in which power feeding is performed by the station-side power supply reception unit 204. Upon an amount of power fed by the local power supply reception unit 202 falling below a prescribed amount in the first state, the ONU 200 transmits a power transmission request signal to the OLT 100 and switches from the first state from the second state via the power feeding switching unit 205. Upon reception of the power transmission request signal, the OLT 100 makes the station-side power supply 110 perform power transmission to a second power reception unit of the ONU 200.

### TECHNICAL FIELD

The present disclosure relates to an optical communication system.

### BACKGROUND ART

Patent Literatures 1, 2, 3 and 4 each disclose a technique relating to an optical communication system including a station-side device and at least one user-side device connected to the station-side device via an optical channel. Each patent literature discloses a method for notifying a station-side device of an abnormality in power feeding condition of a user-side device.

### CITATION LIST

### Patent Literature

Patent Literature 1: Japanese Patent Laid-Open No. 2013-74427

Patent Literature 2: International Publication No. WO 2011/117917

Patent Literature 3: Japanese Patent Laid-Open No. 2011-103532

Patent Literature 4: Japanese Patent Laid-Open No. 2014-158236

### SUMMARY OF THE INVENTION

### Technical Problem

In the conventional techniques disclosed in the above patent literatures, etc., if a station-side device is notified of an abnormality in power feeding condition of a user-side device, for example, it is necessary to send a worker to the site to perform work for recovery of the user-side device. In the conventional techniques, if an amount of power fed in the user-side device decreases because of an abnormality, it is difficult to quickly recover the user-side device.

The present disclosure has been made in order to solve the aforementioned problem. An object of the present disclosure is to, in an optical communication system, enable quick recovery of a user-side device where an amount of power fed in the user-side device decreases.

### Means for Solving the Problem

An optical communication system according to a first aspect of the present disclosure includes a station-side device, and at least one user-side device connected to the station-side device via an optical channel. The user-side device includes a first power reception unit, a second power reception unit and a power feeding switching unit. The first power reception unit is capable of receiving power from an external power supply. The second power reception unit is connected to a station-side power supply controlled by the station-side device, via a power supply cable and is capable of receiving power from the station-side power supply. The power feeding switching unit is capable of selectively switching a state of the user-side device between a first state in which power feeding is performed by the first power reception unit and a second state in which power feeding is performed by the second power reception unit. Upon an amount of power fed by the first power reception unit falling below a prescribed amount in the first state, the user-side device transmits a power transmission request signal to the station-side device and switches from the first state to the second state via the power feeding switching unit. Upon reception of the power transmission request signal, the station-side device makes the station-side power supply perform power transmission to the second power reception unit of the user-side device that is a transmission source of the power transmission request signal.

Also, an optical communication system according to a second aspect of the present disclosure includes a station-side device, and at least one user-side device connected to the station-side device via an optical channel. The user-side device includes a first power reception unit, a second power reception unit and a power feeding switching unit. The first power reception unit is capable of receiving power from an external power supply. The second power reception unit is connected to a station-side power supply controlled by the station-side device, via a power supply cable and is capable of receiving power from the station-side power supply. The power feeding switching unit is capable of selectively switching a state of the user-side device between a first state in which power feeding is performed by the first power reception unit and a second state in which power feeding is performed by the second power reception unit. Upon an amount of power fed by the first power reception unit falling below a prescribed amount in the first state, the user-side device transmits a power transmission request signal to the station-side device and switches from the first state to the second state via the power feeding switching unit. Upon reception of the power transmission request signal, the station-side device makes the station-side power supply perform power transmission of an amount of power, the amount corresponding to a number of the power transmission request signal received.

### Effects of the Invention

The optical communication system according to the present disclosure enables supply of power from the station-side device side to a user-side device where an amount of power fed in the user-side device decreases. Consequently, quick recovery of the user-side device is enabled.

### BRIEF DESCRIPTION OF DRAWINGS

FIG. 1 is a diagram schematically illustrating an overall configuration of an optical communication system according to Embodiment 1.

FIG. 2 is a flowchart illustrating an example of operation of an ONU (user-side device) of Embodiment 1.

FIG. 3 is a flowchart illustrating an example of operation of an OLT (station-side device) of Embodiment 1.

FIG. 4 is a flowchart illustrating a first alteration of operation of an ONU (user-side device) of Embodiment 1.

FIG. 5 is a flowchart illustrating a first alteration of operation of the OLT (station-side device) of Embodiment 1.

FIG. 6 is a flowchart illustrating a second alteration of operation of an ONU (user-side device) of Embodiment 1.

FIG. 7 is a flowchart illustrating a second alteration of operation of the OLT (station-side device) of Embodiment 1.

FIG. 8 is a diagram schematically illustrating an overall configuration of an optical communication system according to Embodiment 2.

FIG. 9 is a flowchart illustrating an example of operation of an ONU (user-side device) of Embodiment 2.

FIG. 10 is a flowchart illustrating an example of operation of an OLT (station-side device) of Embodiment 2.

FIG. 11 is a flowchart illustrating a first alteration of operation of an ONU (user-side device) of Embodiment 2.

FIG. 12 is a flowchart illustrating a first alteration of operation of the OLT (station-side device) of Embodiment 2.

FIG. 13 is a flowchart illustrating a second alteration of operation of an ONU (user-side device) of Embodiment 2.

FIG. 14 is a flowchart illustrating a second alteration of operation of the OLT (station-side device) of Embodiment 2.

### DESCRIPTION OF EMBODIMENTS

Embodiments will be described with reference to the accompanying drawings. In the drawings, signs that are the same denote parts that are identical to or correspond to each other. Also, in the present disclosure, overlapping descriptions are appropriately abbreviated or omitted. Note that the present disclosure is not limited to the below embodiments. The present disclosure can embrace various alterations and combinations of configurations disclosed in the below embodiments without departing from the spirit of the disclosure.

### Embodiment 1

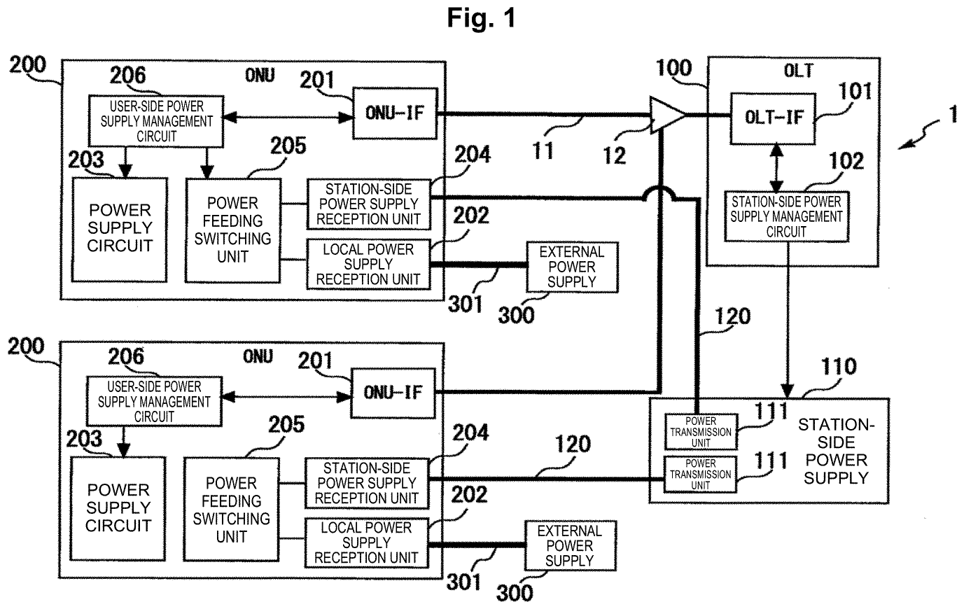

FIG. 1 is a diagram schematically illustrating an overall configuration of an optical communication system 1 according to Embodiment 1. The optical communication system 1 includes a station-side device 100 and at least one user-side device 200. The user-side device 200 is connected to the station-side device 100 via an optical channel. In the below description of the embodiment, the optical communication system 1 is a PON (passive optical network) system. The station-side device 100 is hereinafter referred to as “OLT (optical line termination or optical line terminal) 100”. The user-side device 200 is hereinafter referred to as “ONU (optical network unit) 200”. In the example illustrated in FIG. 1, the optical communication system 1 includes two ONUS 200. Note that the optical communication system 1 may include three or more ONUS 200.

As described above, each of the ONUS 200 is connected to the OLT 100 via an optical channel. More specifically, an ONU interface 201 included in each ONU 200 and an OLT interface 101 included in the OLT 100 are connected via an optical fiber cable 11. A splitter 12 for splitting an optical signal into a plurality of optical signals is provided in the optical fiber cable 11. The OLT 100 performs optical communication with the respective ONUS 200.

In normal times, each ONU 200 operates with power supplied from an external power supply 300 such as a commercial power supply (AC power supply). Each ONU 200 includes a local power supply reception unit 202 as a first power reception unit capable of receiving power from the external power supply 300. The local power supply reception unit 202 is connected to the external power supply 300 via, for example, a power supply cable 301.

Each ONU 200 includes a power supply circuit 203 for generating power for the ONU 200 to operate. In normal times, the power supply circuit 203 generates output power necessary for operation of the ONU 200 from input power received by the local power supply reception unit 202.

As illustrated in FIG. 1, the optical communication system 1 according to the present embodiment includes a station-side power supply 110, which is a power supply controlled by the OLT 100. Each ONU 200 includes a station-side power supply reception unit 204 as a second power reception unit connected to the station-side power supply 110 via a corresponding power supply cable 120. The station-side power supply reception unit 204 is configured to be capable of receiving power from the station-side power supply 110. An ONU 200 according to the present embodiment is configured to be capable of, if power feeding via a local power supply reception unit 202 fails because of, e.g., an abnormality of some sort, performing power feeding via a station-side power supply reception unit 204.

Each ONU 200 includes a power feeding switching unit 205 capable of selectively switching a state of the ONU 200 between a first state in which power feeding is performed by the local power supply reception unit 202 and a second state in which power feeding is performed by the station-side power supply reception unit 204. In normal times, the ONU 200 is in the first state. In the first state, power feeding via the station-side power supply reception unit 204 is disabled. In the first state, as described above, the power supply circuit 203 generates output power necessary for operation of the ONU 200 from input power received by the local power supply reception unit 202. The power feeding switching unit 205 is formed of, for example, a switching element.

The ONU 200 is configured to be capable of, if power feeding via the local power supply reception unit 202 fails because of, e.g., an abnormality of some sort, switching from the first state to the second state. More specifically, in the first state, upon an amount of power fed by the local power supply reception unit 202 falling below a prescribed amount, the ONU 200 switches from the first state to the second state via the power feeding switching unit 205. In the second state, power reception via the station-side power supply reception unit 204 is enabled. In the second state, the power supply circuit 203 generates output power necessary for operation of the ONU 200 from input power received by the power feeding switching unit 205 from the station-side power supply 110.

The ONU 200 includes a user-side power supply management circuit 206 as a user-side device control unit that controls the power feeding switching unit 205. Also, the OLT 100 includes a station-side power supply management circuit 102 as a station-side device control unit that controls the station-side power supply 110.

The ONU 200 has a function that transmits various signals to the OLT 100. Signal transmission operation of the ONU 200 is controlled by, for example, the user-side power supply management circuit 206 that functions as a user-side device control unit. Likewise, the OLT 100 has a function that transmits various signals to the ONU 200. Signal transmission operation of the OLT 100 is controlled by, for example, the station-side power supply management circuit 102 that functions as a station-side device control unit. In the present embodiment, the ONU interface 201 functions as a user-side device signal transmission/reception unit that transmits/receives a signal to/from the OLT 100. The OLT interface 101 functions as a station-side device signal transmission/reception unit that transmits/receives a signal to/from the ONU 200.

As illustrated in FIG. 1, each of the ONUS 200 is connected to the station-side power supply 110 via the corresponding power supply cable 120. In the present embodiment, neither of the power supply cables 120 is split. In the present embodiment, the optical communication system 1 includes a number of power supply cables 120, the number being equal to the number of ONUS 200. The power supply cables 120 are provided independently from each other.

The station-side power supply 110 is configured to be capable of transmitting power to an arbitrary ONU 200. As an example, the station-side power supply 110 includes a first power transmission unit 111 that performs power transmission to a station-side power supply reception unit 204 of a first ONU 200 and a second power transmission unit 111 that performs power transmission to a station-side power supply reception unit 204 of a second ONU 200. The first power transmission unit 111 and the second power transmission unit 111 can operate independently from each other. The station-side power supply 110 can stop power transmission to the second ONU 200 while performing power transmission to the first ONU 200. The station-side power supply 110 is configured to be capable of selecting a power transmission target ONU 200. Operation of, e.g., power transmission target selection by the station-side power supply 110 is controlled by the station-side power supply management circuit 102.

As described above, upon an amount of power fed by a local power supply reception unit 202 falling below a prescribed amount in the first state, an ONU 200 switches from the first state to the second state via a power feeding switching unit 205. Upon the amount of power fed by the local power supply reception unit 202 falling below the prescribed amount in the first state, furthermore, the ONU 200 transmits a power transmission request signal to the OLT 100. Then, upon reception of the power transmission request signal, the OLT 100 makes the station-side power supply 110 perform power transmission to a station-side power supply reception unit 204 of the ONU 200 that is a transmission source of the power transmission request signal. The above configuration enables supply of power from the OLT 100 side to an ONU 200 where an amount of power fed in the ONU 200 decreases and thus enables quick recovery of the ONU 200.

In the present embodiment, the OLT 100 has a function that identifies an ONU 200 that is a transmission source of a power transmission request signal. The function that identifies an ONU 200 that is a transmission source of a power transmission request signal is implemented by, for example, the station-side power supply management circuit 102.

Note that a power transmission request signal is defined as, for example, a dying gasp signal indicating that an amount of power fed in an ONU 200 has fallen below a prescribed amount. Also, although the station-side power supply 110 is illustrated outside the OLT 100 in FIG. 1, the station-side power supply 110 may be installed in the OLT 100.

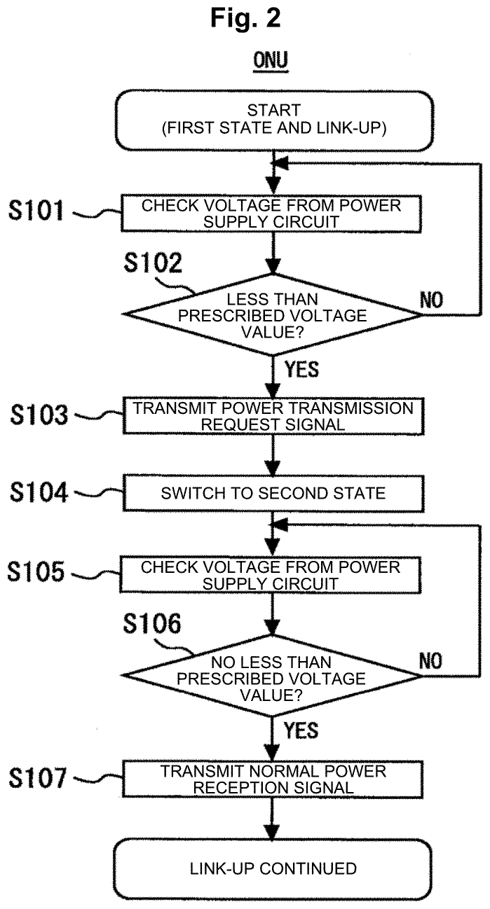

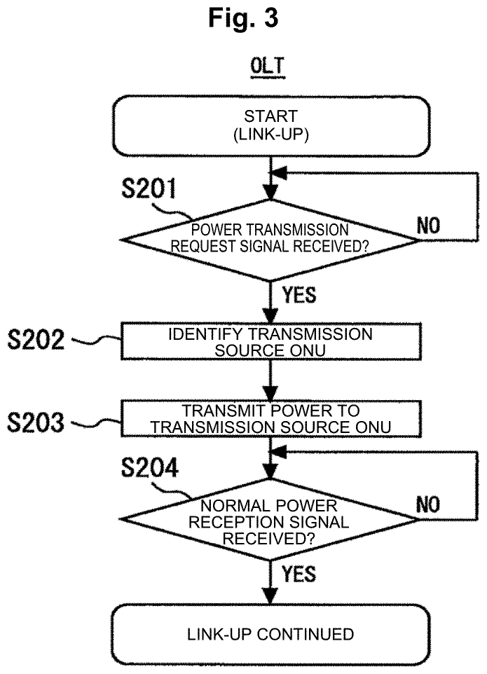

Next, specific examples of operation of the optical communication system 1 configured as described above will be described with reference to flowcharts. FIG. 2 is a flowchart illustrating an example of operation of an ONU 200 of Embodiment 1. FIG. 3 is a flowchart illustrating an example of operation of the ONU 200 of Embodiment 1. First, an example of operation of an ONU 200 in Embodiment 1 will be described with reference to the flowchart in FIG. 2.

In normal times, an ONU 200 is in the first state and operates with power supplied from an external power supply 300 to a local power supply reception unit 202. In normal times, a link-up between the ONU 200 and the OLT 100 is established and the ONU 200 and the OLT 100 perform optical communication with each other. In this state, the ONU 200 determines whether or not an amount of power fed by the local power supply reception unit 202 has fallen below a prescribed amount.

More specifically, checking of a value of a voltage output by a power supply circuit 203 (step S101) and determination of whether or not the checked voltage value is less than a prescribed voltage value (step S102) are performed. The processing in steps S101 and S102, that is, processing for determination of whether or not the amount of power fed by the local power supply reception unit 202 has fallen below the prescribed amount is continuously performed while the ONU 200 is in the first state.

In step S102, if the ONU 200 determines that the voltage value is less than the prescribed voltage value, that is, if the amount of power fed by the local power supply reception unit 202 has fallen below the prescribed amount, the ONU 200 transmits a power transmission request signal to the OLT 100 (step S103). The power transmission request signal is transmitted from an ONU interface 201 to the OLT interface 101 via the optical fiber cable 11. Also, the ONU 200 performs processing for switching from the first state to the second state via the power feeding switching unit 205, together with the processing in step S103 (step S104). Note that either the processing in step S103 or the processing in step S104 may be performed first or the processing in step S103 and the processing in step S104 may be performed simultaneously. It is desirable that the processing in step S103 and the processing in step S104 be performed immediately if the amount of power fed by the local power supply reception unit 202 has fallen below the prescribed amount.

In the present embodiment, the ONU 200 performs processing for transmitting information relating to a power feeding condition of the ONU 200 in the second state to the OLT 100. For example, if an amount of power fed by a station-side power supply reception unit 204 is no less than a prescribed amount, the ONU 200 transmits a normal power reception signal to the OLT 100 as a signal indicating that power reception via the station-side power supply reception unit 204 has normally been done. The normal power reception signal is a signal indicating that power for operation of the ONU 200 has been secured. The normal power reception signal is transmitted from the ONU interface 201 to the OLT interface 101 via the optical fiber cable 11. A normal power reception signal is defined as, for example, a living gasp signal that is opposite to a dying gasp signal.

More specifically, after the processing in steps S103 and S104, the ONU 200 performs checking of the value of the voltage output by the power supply circuit 203 (step S105) and determination of whether or not the checked voltage value is no less than a prescribed voltage value (step S106), respectively. The processing in steps S105 and S106, that is, processing for determination of whether or not the amount of power fed by the station-side power supply reception unit 204 is no less than the prescribed amount is continuously performed while the ONU 200 is in the second state.

In step S106, if the ONU 200 determines that the voltage value is no less than the prescribed voltage value, that is, if the ONU 200 determines that the amount of power fed by the station-side power supply reception unit 204 is no less than the prescribed amount, the ONU 200 transmits a normal power reception signal to the OLT 100 (step S107). Then, the link-up between the ONU 200 and the OLT 100 is continued.

Note that during performance of the processing in steps S105 and S106, a case where the value of the voltage output by the power supply circuit 203 does not reach no less than the prescribed value means that power feeding via the station-side power supply reception unit 204 is not normally performed. In this case, eventually, the power for operation of the ONU 200 becomes no longer secured, resulting in a state in which the link between the ONU 200 and the OLT 100 is broken. This state can be confirmed from the OLT 100 side. Also, for example, the optical fiber cable 11 being cut results in a state in which the link between the ONU 200 and the OLT 100 is broken. In the above cases in which power feeding via the station-side power supply reception unit 204 is not performed normally, checking of a condition of, and recovery of, the optical communication system 1 can be performed by, e.g., sending a worker.

Next, an example of operation of the OLT 100 in Embodiment 1 will be described with reference to the flowchart in FIG. 3. The OLT 100 performing optical communication with the ONUS 200 determines whether or not the OLT 100 has received a power transmission request signal (step S201). The processing in step S201 is continuously performed.

The OLT 100 that has received a power transmission request signal identifies an ONU 200 that is a transmission source of the power transmission request signal (step S202). The OLT 100 makes the station-side power supply 110 perform power transmission to the ONU 200 that is the transmission source of the received power transmission request signal (step S203). Consequently, power supply to the ONU 200 by the station-side power supply 110 is started.

As described above, the ONU 200 performs processing for transmitting information relating to a power feeding condition of the ONU 200 in the second state to the OLT 100. After the start of the power supply to the ONU 200 by the station-side power supply 110, the OLT 100 receives the information relating to the power feeding condition of the ONU 200. The present embodiment enables information relating to a power feeding condition of an ONU 200 after a start of power supply to the ONU 200 by the station-side power supply 110 to be grasped on the OLT 100 side.

For example, after the start of power supply to the ONU 200 by the station-side power supply 110, the OLT 100 determines whether or not the OLT 100 has received a normal power reception signal from the ONU 200 (step S204). Upon the OLT 100 receiving a normal power reception signal, that is, upon power supply from the station-side power supply 110 to the station-side power supply reception unit 204 being normally done, a link-up between the ONU 200 and the OLT 100 is continued.

Note that a case where no normal power reception signal has been received even if the determination processing in step S204 is continued for a certain period of time means that power feeding via the station-side power supply reception unit 204 is not normally performed. If a timeout occurs with no normal power reception signal being received even though the determination processing in step S204 is continued for a certain period of time, checking of a condition of, and recovery of, the optical communication system 1 can be performed by, e.g., sending a worker.

As illustrated in the flowchart in FIG. 2, in the present embodiment, each ONU 200 has a function that makes various determinations. A function as a user-side device determination unit that makes various determinations necessary for operation of the ONU 200 is implemented by, for example, a user-side power supply management circuit 206, which is a user-side device control unit. Also, as illustrated in the flowchart in FIG. 3, the OLT 100 has a function that makes various determinations. A function as a station-side device determination unit that makes various determinations necessary for operation of the OLT 100 is implemented by, for example, the station-side power supply management circuit 102, which is a station-side device control unit.

More specifically, various functions of the user-side power supply management circuit 206 and the station-side power supply management circuit 102 in the present embodiment are implemented by, e.g., controllers that perform information processing. Typically, each controller includes a processor and a memory. The memory includes a volatile memory and a non-volatile memory. The functions of the user-side power supply management circuit 206 and the station-side power supply management circuit 102 are implemented by execution of respective control programs stored in the respective memories, by the respective processors. Each control program can be recorded on a computer-readable recording medium. Each controller may be implemented using hardware such as an ASIC (application-specific integrated circuit), a PLD (programmable logic device) or an FPGA (field-programmable gate array). Also, each controller may be implemented by a combination of dedicated hardware and software.

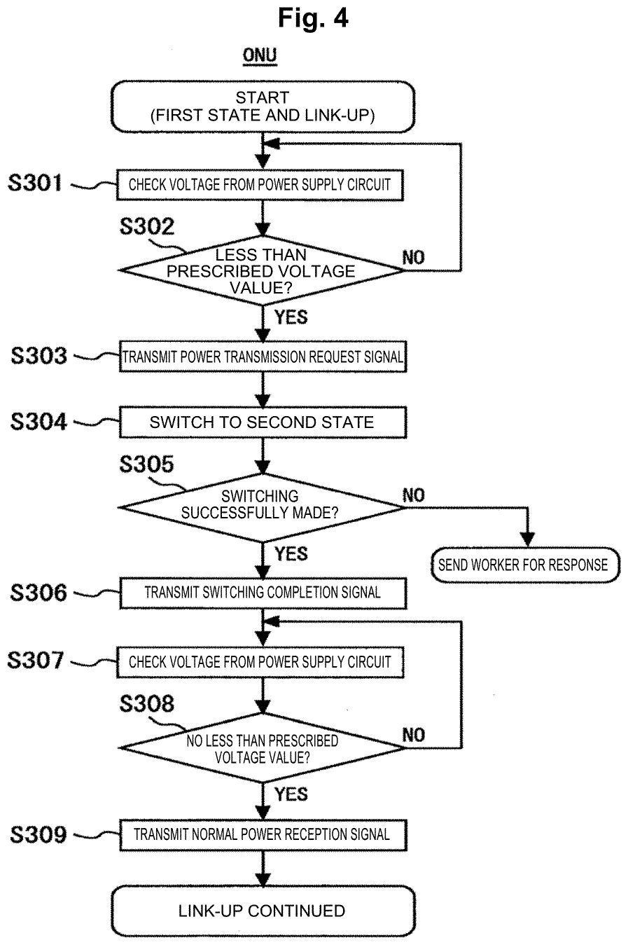

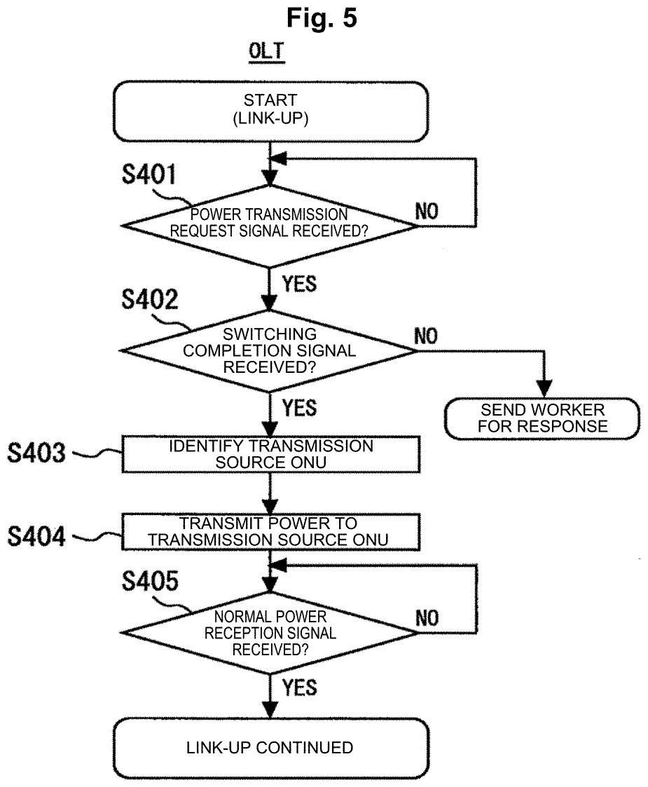

Also, FIGS. 4 and 5 are flowcharts illustrating a first alteration of the optical communication system 1 of Embodiment 1. FIG. 4 is a flowchart illustrating a first alteration of operation of an ONU 200 of Embodiment 1. FIG. 5 is a flowchart illustrating a first alteration of operation of the OLT 200 of Embodiment 1.

The processing in steps S301 to S304 in the flowchart in FIG. 4 is similar to the above-described processing in steps S101 to S104, and thus, detailed description thereof is omitted. Either the processing in step S303 or the processing in step S304 may be performed first or the processing in step S303 and the processing in step S304 may be performed simultaneously.

In the first alteration, after performance of processing for switching from the first state to the second state, an ONU 200 determines whether or not switching to the second state has been successfully made (step S305). If the switching has not been successfully made for some reason such as a failure of the device, a response such as sending a worker is made. At this time, the ONU 200 may transmit a signal indicating that the switching has not been successfully made to the OLT 100 side or notifies a user of the ONU 200 of the switching being not successfully made.

In the first alteration, if the switching to the second state has been successfully made, the ONU 200 transmits a switching completion signal to the OLT 100 as information relating to a power feeding condition of the ONU 200 in the second state (step S306). The processing in steps S307 to S309 is similar to the above-described processing in steps S105 to S107 and detailed description thereof is omitted.

As illustrated in FIG. 5, in the first alteration, as with the above-described processing in step S201, the ONU 200 determines whether or not the ONU 200 has received a power transmission request signal (step S401). In the first alteration, the ONU 200 further determines whether or not the ONU 200 has received a switching completion signal, together with the processing in step S401 (step S402). If the ONU 200 has received no switching completion signal, a response such as sending a worker is made. Note that either the processing in step S401 or the processing in step S402 may be performed first or the processing in step S401 and the processing in step S402 may be performed simultaneously. The processing in steps S403 to S405 subsequent to step S402 is similar to the above-described processing in steps S202 to S204, and thus, detailed description thereof is omitted.

The first alteration illustrated in FIGS. 4 and 5 enables detailed information relating to a power feeding condition of an ONU 200 to be grasped on the OLT 100 side. For example, if switching of a state of an ONU 200 to the second state fails, it is possible to make a response such as sending a worker. Also, it is possible to avoid unnecessary power transmission from a station-side power supply 110 to an ONU 200 in a case where switching of a state of the ONU 200 to the second state fails.

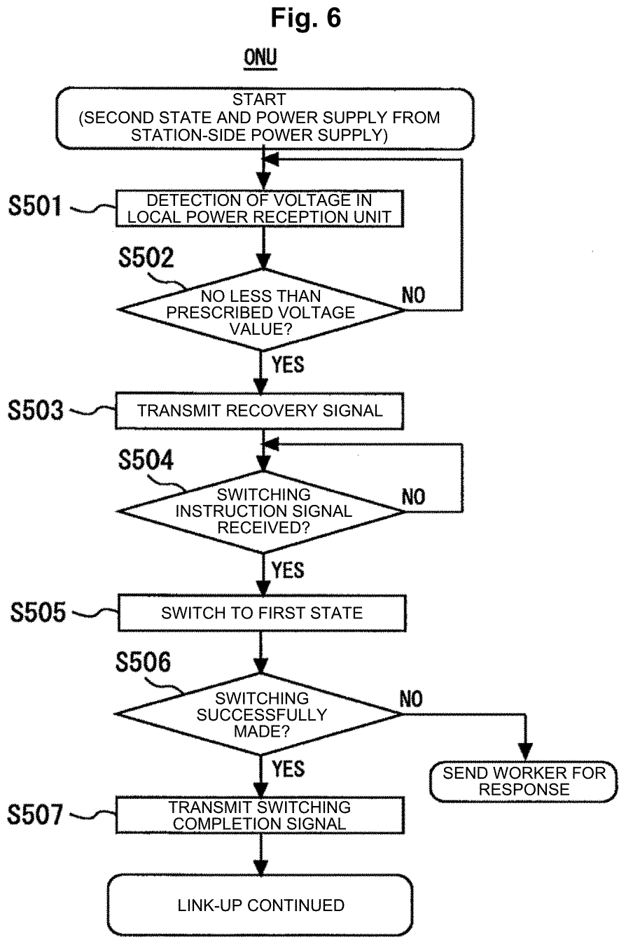

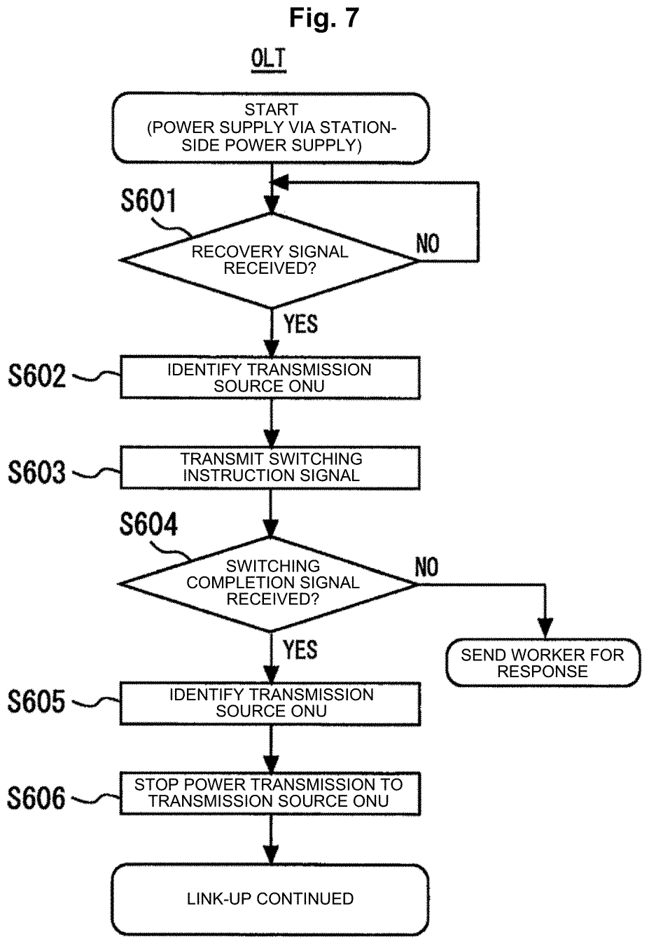

Also, FIGS. 6 and 7 are flowcharts illustrating a second alteration of the optical communication system 1 of Embodiment 1. FIG. 6 is a flowchart illustrating a second alteration of operation of an ONU 200 of Embodiment 1. FIG. 7 is a flowchart illustrating a second alteration of operation of the OLT 200 of Embodiment 1. FIGS. 6 and 7 each illustrate an example of operation of the optical communication system 1 in a state in which power is supplied to an ONU 200 by the station-side power supply 110. In the second alteration, an ONU 200 is configured to, if an amount of power that can be fed by a local power supply reception unit 202 has reached no less than a prescribed amount in the second state, switch from the second state to the first state via a power feeding switching unit 205. Examples of a case where an amount of power that can be fed by a local power supply reception unit 202 has reached no less than a prescribed amount include, e.g., a case where a plug of a power supply cable 301 has been inserted to an external power supply 300 again after being removed from the external power supply 300 once and a case where an abnormality that hinders power feeding via the local power supply reception unit 202 has been eliminated.

In the second alteration, the ONU 200 determines whether or not the amount of power that can be fed by the local power supply reception unit 202 has reached no less than the prescribed amount in the second state. More specifically, detection of a voltage supplied to the local power supply reception unit 202 from the external power supply 300 (step S501) and determination of whether or not the detected voltage value is no less than a prescribed voltage value (step S502) are performed. The processing in steps S501 and S502, that is, processing for determining whether or not the amount of power that can be fed by the local power supply reception unit 202 has reached no less than the prescribed amount is continuously performed while the ONU 200 is in the second state. Then, if the amount of power that can be fed by the local power supply reception unit 202 has reached no less than the prescribed amount, the ONU 200 switches from the second state to the first state via the power feeding switching unit 205.

Note that switching from the second state to the first state in a case where the amount of power that can be fed by the local power supply reception unit 202 has reached no less than the prescribed amount may be made after reception of an instruction from the OLT 100. For example, as illustrated in the example in FIG. 6, if the amount of power that can be fed by the local power supply reception unit 202 has reached no less than the prescribed amount, the ONU 200 may transmit a recovery signal to the OLT 100 (step S503). The recovery signal is a signal indicating that power feeding via the local power supply reception unit 202 is enabled again. A recovery signal is defined as, for example, a living gasp signal, which has been mentioned above.

In the second alteration, as illustrated in FIG. 7, during power supply to ONUS 200 via a station-side power supply 110, the OLT 100 may determine whether or not the OLT 100 has received a recovery signal (step S601). The processing in step S601 is continuously performed. The OLT 100 that has received a recovery signal identifies an ONU 200 that is a transmission source of the recovery signal (step S602) and transmits a switching instruction signal to the ONU 200 that is the transmission source of the recovery signal (step S603).

As illustrated in FIG. 6, the ONU 200 that has transmitted the above-described recovery signal determines whether or not the ONU 200 has received the switching instruction signal (step S504). The determination processing in step S504 is continuously performed. Upon reception of the switching instruction signal, the ONU 200 performs processing for switching from the second state to the first state via the power feeding switching unit 205 (step S505).

The ONU 200 that has performed the processing for switching from the second state to the first state determines whether or not the switching to the first state has been successfully made (step S506). If the switching has not been successfully made for some reason such as a failure of the device, a response such as sending a worker is made. At this time, the ONU 200 may transmit a signal indicating that the switching has not been unsuccessfully made, to the OLT 100 side or may notify a user of the ONU 200 of the switching being not successfully made. Upon the switching from the second state to the first state being successfully made, the ONU 200 transmits a switching completion signal to the OLT 100 (step S507). The ONU 200 that has entered the first state operates with power supplied from an external power supply 300 to a local power supply reception unit 202. Then, a link-up between the ONU 200 and the OLT 100 is continued.

As illustrated in FIG. 7, the OLT 100 that had transmitted the above-described switching instruction signal determines whether or not the OLT 100 has received a switching completion signal (step S604). If the OLT 100 that had transmitted the switching instruction signal has received no switching completion signal, a response such as sending a worker is made. Upon reception of the switching completion signal, the OLT 100 identifies an ONU 200 that is a transmission source of the switching completion signal (step S605). Then, the OLT 200 makes the station-side power supply 110 stop power transmission to a station-side power supply reception unit 204 of the ONU 200 that is the transmission source of the switching completion signal (step S606). Then, the link-up between the ONU 200 and the OLT 100 is continued.

According to the second alteration described above, operation of returning an ONU 200 from the second state to the first state is automatically performed where normal power feeding via a local power supply reception unit 202 is enabled. Also, according to the examples in FIGS. 6 and 7, it is possible to control the operation of returning the ONU 200 from the second state to the first state, remotely from the OLT 100 side. Also, according to the examples in FIGS. 6 and 7, it is possible to properly stop unnecessary power supply from the station-side power supply 110 to an ONU 200 in which normal power feeding via a local power supply reception unit 202 is enabled.

### Embodiment 2

Next, Embodiment 2 will be described. Description of parts that are identical or correspond to those of Embodiment 1 is abbreviated or omitted. In the below, differences from Embodiment 1 will mainly be described.

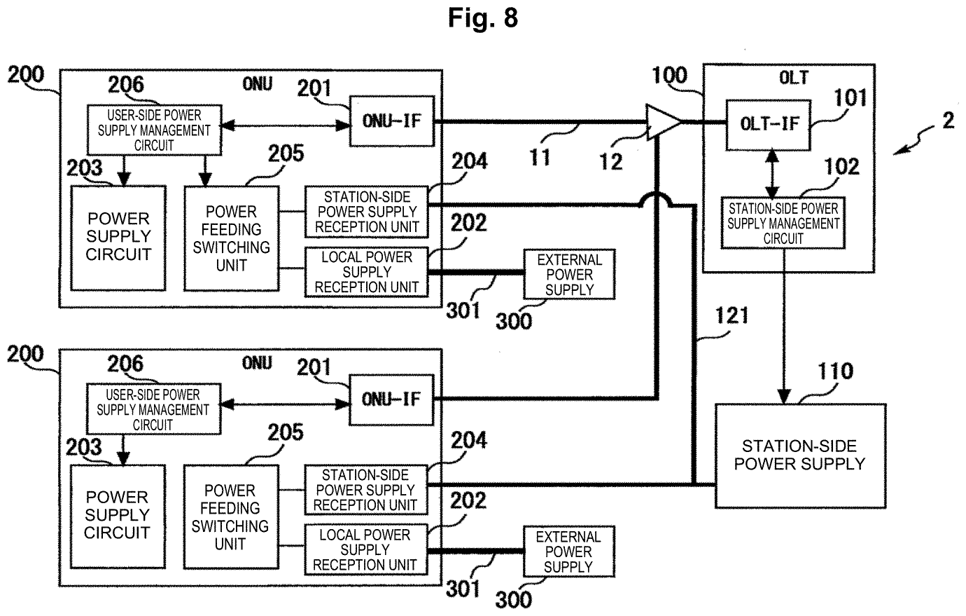

FIG. 8 is a diagram schematically illustrating an overall configuration of an optical communication system 2 according to Embodiment 2. As with the optical communication system 1 of Embodiment 1, the optical communication system 2 includes an OLT 100 and at least one ONU. In the example illustrated in FIG. 8, the optical communication system 2 includes two ONUS 200. The optical communication system 2 may include three or more ONUS 200. Each of the ONUS 200 is connected to the OLT 100 via an optical fiber cable 11.

As in the optical communication system 1 of Embodiment 1, the optical communication system 2 includes a station-side power supply 110, which is a power supply controlled by the OLT 100. Each ONU 200 includes a station-side power supply reception unit 204 as a second power reception unit configured to be capable of receiving power from the station-side power supply 110. As in Embodiment 1, each ONU 200 includes a power feeding switching unit 205 capable of selectively switching a state of the ONU 200 between a first state in which power feeding is performed by a local power supply reception unit 202 and a second state in which power feeding is performed by the station-side power supply reception unit 204.

In the present embodiment, as illustrated in FIG. 8, each of the OLTs 200 is connected to the station-side power supply 110 via a power supply cable 121. In the present embodiment, the ONU 200 side of the power supply cable 121 is split. One end side of the power supply cable 121 is connected to the station-side power supply 110 without being split. Another end side of the power supply cable 121 is split in a number that is the same as the number of ONUs 200. Each of the split other end sides of the power supply cable 121 is connected to the station-side power supply reception unit 204 of the corresponding one of the ONUs 200. In the present embodiment, the station-side power supply 110 is configured to transmit power to respective ONUs 200 simultaneously.

As in Embodiment 1, upon an amount of power fed by a local power supply reception unit 202 falling below a prescribed amount in the first state, an ONU 200 switches from the first state to the second state via a power feeding switching unit 205. Upon the amount of power fed by the local power supply reception unit 202 falling below the prescribed amount in the first state, furthermore, the ONU 200 transmits a power transmission request signal to the OLT 100.

In the present embodiment, the OLT 100 has a function that determines the number of power transmission request signals received. The OLT 100 is configured to operate according to the number of power transmission request signals received. For example, the OLT 100 has a function that calculates a necessary amount of power to be transmitted, according to the number of power transmission request signals received. In the present embodiment, upon reception of power transmission request signals, the OLT 100 makes the station-side power supply transmit an amount of power, the amount corresponding to the number of power transmission request signals received. The above functions of the OLT 100 are implemented by, for example, a station-side power supply management circuit 102. As in Embodiment 1, the above configuration enables supply of power from the OLT 100 side to ONUS 200 in a case where amounts of power fed in the ONUS 200 decrease and thus enables quick recovery of the ONUS 200.

As in Embodiment 1, a power transmission request signal is defined as, for example a dying gasp signal. Also, although the station-side power supply 110 is illustrated outside the OLT 100 in FIG. 8, the station-side power supply 110 may be installed in the OLT 100.

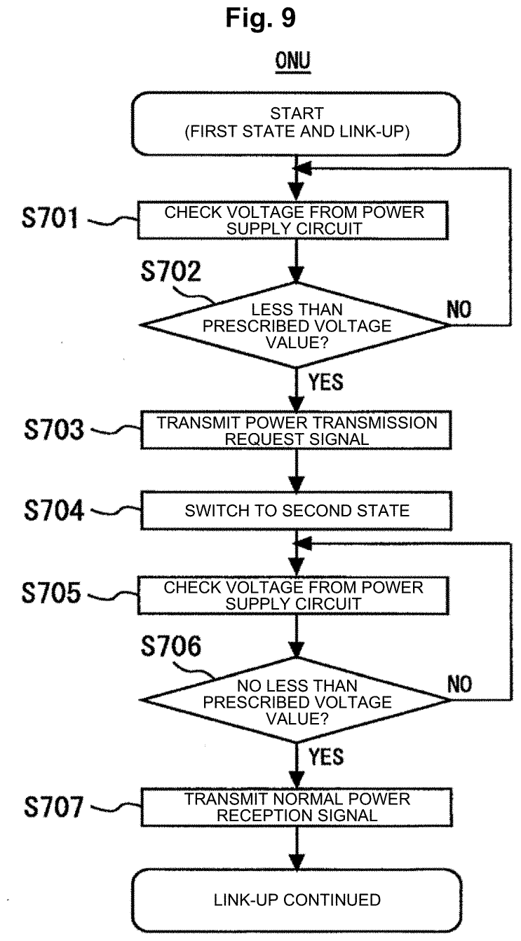

Specific examples of operation of the optical communication system 2 configured as described above will be described with reference to flowcharts. FIG. 9 is a flowchart illustrating an example of operation of an ONU 200 of Embodiment 2. In the example in FIG. 9, an ONU 200 operates in a manner that is similar to the example in FIG. 2 in Embodiment 1. The processing in steps S701 to S707 in FIG. 9 is similar to the processing in steps S101 to S107 in FIG. 2, and thus, detailed description thereof is omitted.

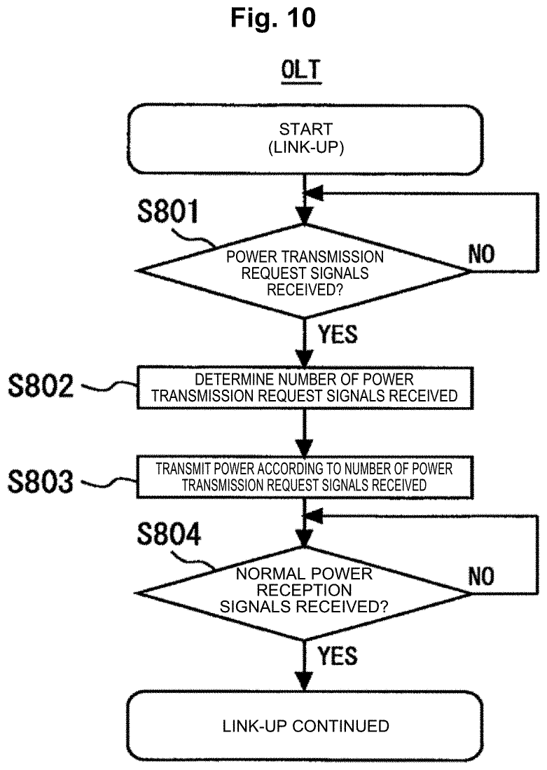

FIG. 10 is a flowchart illustrating an example of operation of the OLT 100 of Embodiment 2. As in Embodiment 1, the OLT 100 performing optical communication with the ONUS 200 determines whether or not the OLT 100 has received power transmission request signals (step S801). The processing in step S801 is continuously performed.

The OLT 100 that has received power transmission request signals determines the number of power transmission request signals received (step S802). Then, the OLT 100 makes the station-side power supply 110 transmit an amount of power, the amount corresponding to the number of power transmission request signals received (step S803). As described above, the station-side power supply 110 transmits power to respective ONUS 200 simultaneously. In each of ONUS 200 in the second state from among the ONUS 200, the station-side power supply reception unit 204 receives power from the station-side power supply 110. Consequently, supply of power to the ONUS 200 by the station-side power supply 110 is started.

As in Embodiment 1, each ONU 200 performs processing for transmitting information relating to a power feeding condition of the ONU 200 in the second state to the OLT 100. For example, after the start of supply of power to the ONUS 200 by the station-side power supply 110, the OLT 100 determines whether or not the OLT 100 has received normal power reception signals from the ONUS 200 (step S804). Upon reception of normal power reception signals, that is, upon power supply from the station-side power supply 110 to the station-side power supply reception unit 204 being normally done, respective link-ups between the ONUS 200 and the OLT 100 are continued. If a timeout occurs with no normal power reception signal being received even though the determination processing in step S804 is continued for a certain period of time, checking of a condition of, and recovery of, the optical communication system 2 can be performed by, e.g., sending a worker.

As in Embodiment 1, various determination functions of the ONU 200 in the present embodiment are implemented by, for example, a user-side power supply management circuit 206. Likewise, various determination functions of the OLT 100 are implemented by, for example, the station-side power supply management circuit 102.

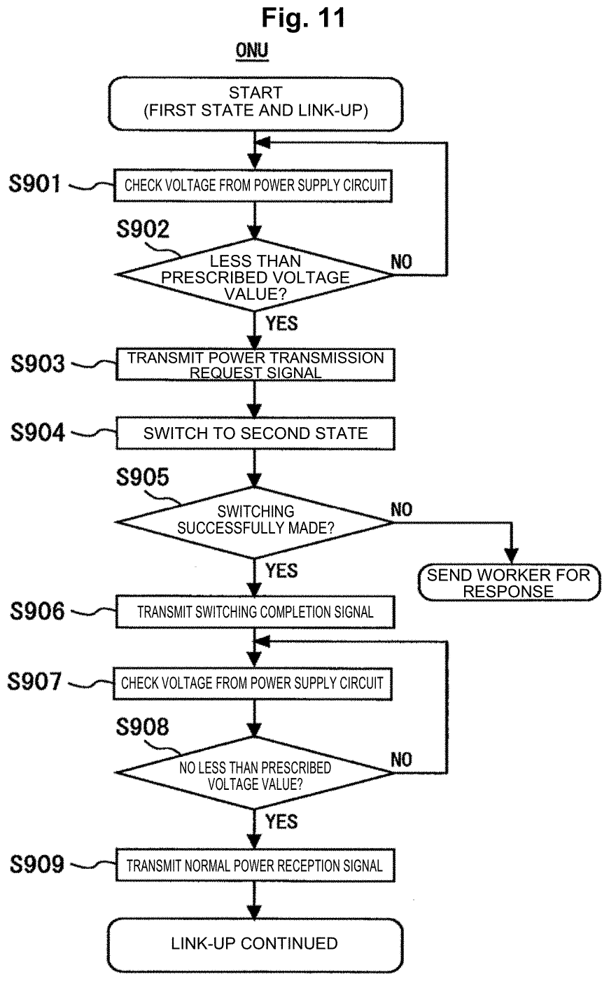

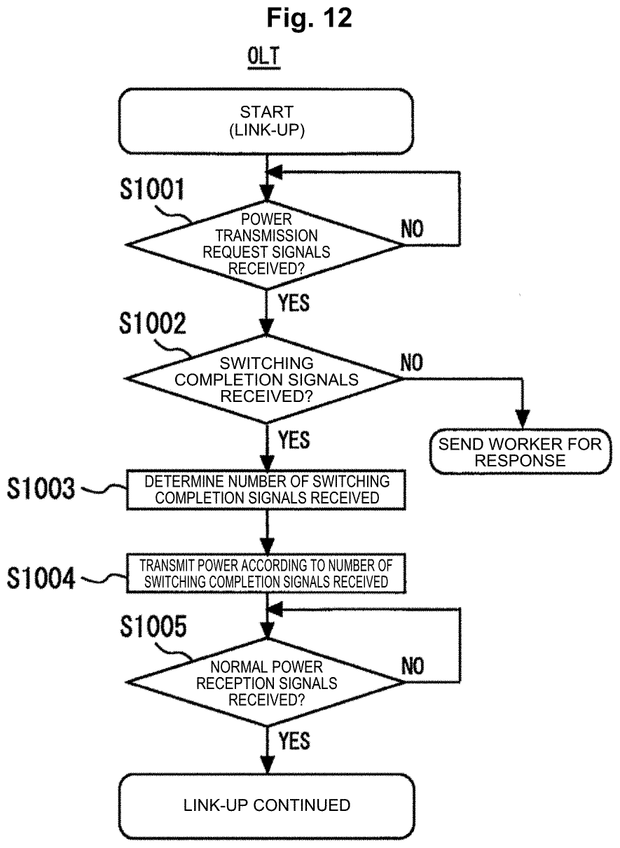

FIGS. 11 and 12 are flowcharts illustrating a first alteration of the optical communication system 2 of Embodiment 2. FIG. 11 is a flowchart illustrating a first alteration of operation of an ONU 200 of Embodiment 2. FIG. 12 is a flowchart illustrating a first alteration of operation of the OLT 200 of Embodiment 2. In the example in FIG. 11, an ONU 200 operates in a manner that is similar to the example in FIG. 4 in Embodiment 1. The processing in steps S901 to S909 in FIG. 11 is similar to the processing in steps S301 to S309 in FIG. 4, and thus, detailed description thereof is omitted.

As illustrated in FIG. 12, in the first alteration, as in the above-described processing in step S801, the ONU 200 determines whether or not the ONU 200 has received power transmission request signals (step S1001). In the first alteration, the ONU 200 further determines whether or not ONU 200 has received switching completion signals, together with the processing in step S1001 (step S1002). If the ONU 200 has received no switching completion signal, a response such as sending a worker is made. Note that either the processing in step S1001 or the processing in step S1002 may be performed first or the processing in step S1001 and the processing in step S1002 may be performed simultaneously. The processing in the processing in steps S1003 to step S1005 subsequent to step S1002 is similar to the above-described processing in steps S802 to S804, and thus, detailed description thereof is omitted.

The first alteration enables detailed information relating to a power feeding condition of an ONU 200 to be grasped on the OLT 100 side. Also, it is possible to avoid unnecessary power transmission from the station-side power supply 110 to an ONU 200 in a case where switching of a state of the ONU 200 to the second state fails.

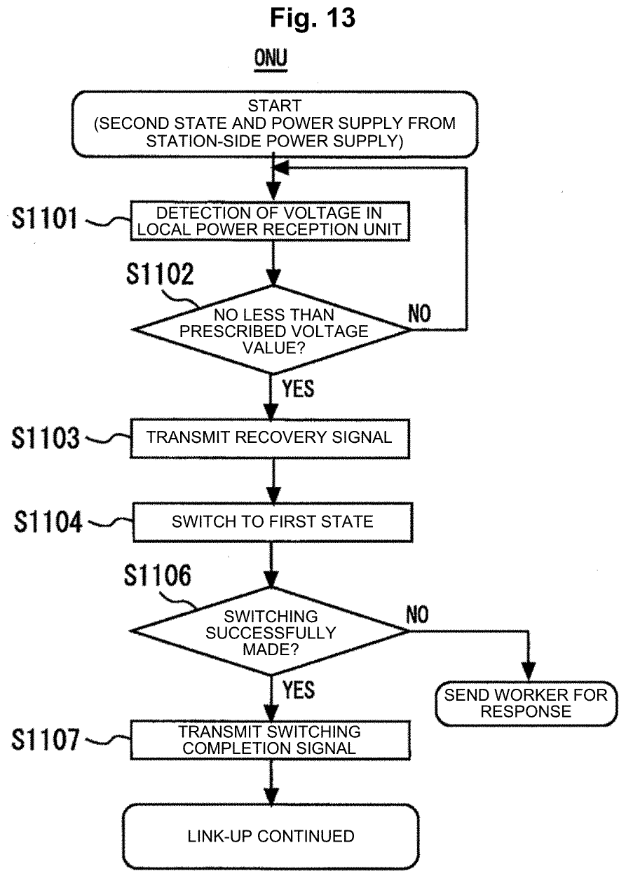

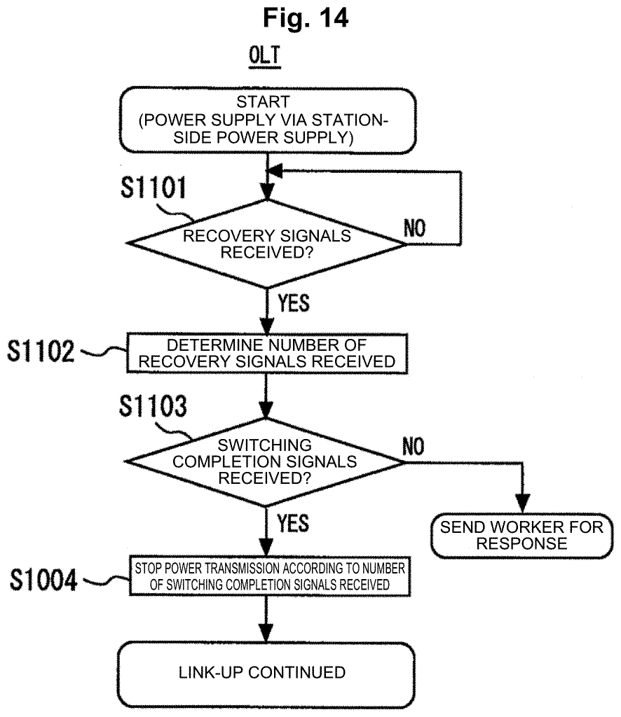

FIGS. 13 and 14 are flowcharts illustrating a second alteration of the optical communication system 2 of Embodiment 2. FIG. 13 is a flowchart illustrating a second alteration of operation of an ONU 200 of Embodiment 2. FIG. 14 is a flowchart illustrating a second alteration of operation of the OLT 200 of Embodiment 2. FIGS. 13 and 14 each illustrate an example of operation of an optical communication system 2 in a state in which power is supplied to ONUs 200 by a station-side power supply 110. In the second alteration, an ONU 200 is configured to, upon an amount of power fed by a local power supply reception unit 202 has reached no less than a prescribed amount in the second state, switch from the second state to the first state via a power feeding switching unit 205.

In the second alteration, an ONU 200 determines whether or not an amount of power that can be fed by a local power supply reception unit 202 has reached no less than a prescribed amount in the second state. More specifically, detection of a voltage supplied to the local power supply reception unit 202 from an external power supply 300 (step S1101) and determination of whether or not the detected voltage value is no less than a prescribed voltage value (step S1102) are performed. The processing in steps S1101 and S1102, that is, processing for determining whether or not the amount of power that can be fed by the local power supply reception unit 202 has reached no less than the prescribed amount is continuously performed while the ONU 200 is in the second state.

In the second alteration, if the amount of power that can be fed by local power supply reception unit 202 has reached no less than the prescribed amount, the ONU 200 transmits a recovery signal indicating that power feeding via the local power supply reception unit 202 is enabled again, to the OLT 100 (step S1103). Also, together with the transmission of the recovery signal, the ONU 200 performs processing for switching from the second state to the first state via a power feeding switching unit 205 (step S1104). Either the processing in step S1103 or the processing in step S1104 may be performed first or the processing in step S1103 and the processing in step S1104 may be performed simultaneously.

The ONU 200 that has performed the processing for switching from the second state to the first state may determine whether or not the switching to the first state has been successfully made (step S1106). If the switching has not been successfully made for some reason such as a failure of the device, a response such as sending a worker can be made. At this time, the ONU 200 may transmit a signal indicating that the switching has not been successfully made to the OLT 100 side or may notify a user of the ONU 200 of the switching being not successfully made. If the ONU 200 determines in step S1106 that the switching has successfully been made, the ONU 200 transmits a switching completion signal to the OLT 100 (step S1107).

In the second alteration of Embodiment 2, the OLT 100 has a function that determines the number of recovery signals received. The OLT 100 is configured to operate according to the number of power transmission request signals received. As illustrated in FIG. 14, during power supply to ONUs 200 by a station-side power supply 110, the OLT 100 determines whether or not the OLT 100 has received recovery signals (step S1101). The processing in step S1101 is continuously performed. The OLT 100 that has received recovery signals determines the number of recovery signals received (step S1102).

In the second alteration, the OLT 100 may determine whether or not the OLT 100 has received switching completion signals (step S1103). If the OLT 100 has not received a number of switching completion signals, the number being equal to the number of switching instruction signals corresponding to the number of recovery signals, a response such as sending a worker may be made.

In the second alteration, the station-side power supply is made to stop transmission of an amount of power, the amount corresponding to the number of recovery signals received (step S1004). According to the second alteration described above, operation of returning an ONU 200 from the second state to the first state is automatically performed where normal power feeding via a local power supply reception unit 202 is enabled. Also, it is possible to properly unnecessary power supply from the station-side power supply 110 to ONUs 200 in which normal power feeding via a local power supply reception unit 202 is enabled.

The above-described embodiments and the alterations thereof each enable, in an optical communication system, quick recovery of a user-side device where an amount of power fed in the user-side device decreases. Note that the optical communication system according to the present disclosure is not limited to a PON system such as the optical communication system 1 or the optical communication system 2 indicated by example in the embodiments above. The technique according to the present disclosure is applicable to any optical communication system including a station-side device and a user-side device that communicate with each other via an optical channel. Also, the user-side device included in the optical communication system according to the present disclosure is not limited to those to be installed in, e.g., houses of general users. The station-side device and the user-side device may be, for example, a master-station device installed in a master base station and a slave-station device installed in a slave base station, respectively.

### INDUSTRIAL APPLICABILITY

The optical communication system according to the present disclosure is applicable to, for example, PON systems.

### REFERENCE SIGNS LIST

1 Optical communication system
2 Optical communication system
11 Optical fiber cable
12 Splitter
100 OLT (station-side device)
101 OLT interface
102 Station-side power supply management circuit
110 Station-side power supply
111 Power transmission unit
120 Power supply cable
121 Power supply cable
200 ONU (user-side device)
201 ONU interface
202 Local power supply reception unit
203 Power supply circuit
204 Station-side power supply reception unit
205 Power feeding switching unit
206 User-side power supply management circuit
300 External power supply
301 Power supply cable

1. An optical communication system comprising a station-side device, and at least one user-side device connected to the station-side device via an optical channel, wherein:
the user-side device includes
a first power reception unit capable of receiving power from an external power supply,
a second power reception unit that is connected to a station-side power supply controlled by the station-side device, via a power supply cable and is capable of receiving power from the station-side power supply, and
a power feeding switching unit capable of selectively switching a state of the user-side device between a first state in which power feeding is performed by the first power reception unit and a second state in which power feeding is performed by the second power reception unit;
upon an amount of power fed by the first power reception unit falling below a prescribed amount in the first state, the user-side device transmits a power transmission request signal to the station-side device and switches from the first state to the second state via the power feeding switching unit; and
upon reception of the power transmission request signal, the station-side device makes the station-side power supply perform power transmission to the second power reception unit of the user-side device that is a transmission source of the power transmission request signal.

2. An optical communication system comprising a station-side device, and at least one user-side device connected to the station-side device via an optical channel, wherein:
the user-side device includes
a first power reception unit capable of receiving power from an external power supply,
a second power reception unit that is connected to a station-side power supply controlled by the station-side device, via a power supply cable and is capable of receiving power from the station-side power supply, and
a power feeding switching unit capable of selectively switching a state of the user-side device between a first state in which power feeding is performed by the first power reception unit and a second state in which power feeding is performed by the second power reception unit;
upon an amount of power fed by the first power reception unit falling below a prescribed amount in the first state, the user-side device transmits a power transmission request signal to the station-side device and switches from the first state to the second state via the power feeding switching unit; and
upon reception of the power transmission request signal, the station-side device makes the station-side power supply perform power transmission of an amount of power, the amount corresponding to a number of the power transmission request signal received.

3. The optical communication system according to claim 1, wherein in the second state, the user-side device transmits information relating to a power feeding condition of the user-side device to the station-side device.

4. The optical communication system according to claim 1, wherein upon an amount of power that can be fed by the first power reception unit reaching no less than a prescribed amount in the second state, the user-side device switches from the second state to the first state via the power feeding switching unit.

5. The optical communication system according to claim 1, wherein:
upon an amount of power that can be fed by the first power reception unit reaching no less than a prescribed amount in the second state, the user-side device transmits a recovery signal to the station-side device;
upon reception of the recovery signal, the station-side device transmits a switching instruction signal to the user-side device that is a transmission source of the recovery signal;
the user-side device switches from the second state to the first state via the power feeding switching unit upon reception of the switching instruction signal, and transmits a switching completion signal to the station-side device upon completion of the switching from the second state to the first state; and
upon reception of the switching completion signal, the station-side device makes the station-side power supply stop the power transmission to the second power reception unit of the user-side device that is a transmission source of the switching completion signal.

6. The optical communication system according to claim 2, wherein:
upon an amount of power that can be fed by the first power reception unit reaching no less than a prescribed amount in the second state, the user-side device switches from the second state to the first state via the power feeding switching unit and transmits a recovery signal to the station-side device; and
upon reception of the recovery signal, the station-side device makes the station-side power supply stop power transmission of an amount of power, the amount corresponding to a number of the recovery signal received.
